(19) United States
(12) Patent Application Publication
(10) Pub. No.: US 2014/0294559 A1
(43) Pub. Date: Oct. 2, 2014

(54) MULTIPLE MODE GAS TURBINE ENGINE GAS FUEL SYSTEM WITH INTEGRATED CONTROL

(71) Applicant: SOLAR TURBINES INCORPORATED, San Diego, CA (US)

(72) Inventors: Chad M. Holcomb, San Diego, CA (US); Robert Eleazar Mendoza, Poway, CA (US)

(73) Assignee: Solar Turbines Incorporated, San Diego, CA (US)

(21) Appl. No.: 13/852,292

(22) Filed: Mar. 28, 2013

(51) Int. Cl. F02C 9/26

(52) U.S. Cl. CPC F02C 9/263
USPC 415/1

(57) ABSTRACT

A method for operating a gas turbine engine is disclosed. The method includes determining whether the gas turbine engine fuel system is in a steady state mode or a transient mode. The method also includes modifying the gas turbine engine power output by modifying a pressure set point of the fuel system while maintaining a fuel control valve in a steady state when in the steady state mode. The method further includes modifying the gas turbine engine output by modifying the position of the fuel control valve while maintaining the pressure set point of the fuel system constant when in the transient mode.

### TECHNICAL FIELD

The present disclosure generally pertains to gas turbine engines, and is more particularly directed toward a multiple mode gas fuel system with integrated control.

### BACKGROUND

Gas turbine engines include compressor, combustor, and turbine sections. A fuel system delivers fuel to the combustor fuel nozzles. An external gas compressor may supply the pressure to the fuel system and control valves may be used to regulate the amount of fuel delivered to the fuel nozzles. The fuel system requires careful design and control to provide satisfactory performance.

U.S. Pat. No. 4,922,710 to W. Rowen et. al. discloses an integrated boost compressor/gas turbine control system. A fuel gas compressor boosts the fuel gas pressure before supplying the fuel gas to the gas turbine control valves, namely the stop/-speed ratio or pressure control valve and the gas control or volume valve, which in turn provide the fuel gas to the gas turbine. Pressure drops through these valves and hence boost power requirements are minimized by driving these valves to a fully open position under normal operating conditions, and using the valves in their normal control mode during other operating conditions such as start up and sudden load rejection. Thus, after startup operation, the system control is transitioned to the minimum system pressure drop of operation utilizing boost compressor flow control to control gas turbine fuel flow and hence gas turbine output power.

The present disclosure is directed toward overcoming one or more of the problems discovered by the inventors.

### SUMMARY OF THE DISCLOSURE

A method for operating a gas turbine engine is disclosed. The method includes determining whether the gas turbine engine fuel system is in a steady state mode or a transient mode. The method also includes modifying the gas turbine engine power output to match a change of load or power demand on the gas turbine engine by modifying a pressure set point of the fuel system while maintaining a fuel control valve in a steady state when in the steady state mode. The method further includes configuring the pressure set point of the fuel system to a point higher than a gas turbine engine load requires and modifying the gas turbine engine output to match a change of load or power demand on the gas turbine engine by modifying the position of the fuel control valve while maintaining the pressure set point of the fuel system constant when in the transient mode.

### BRIEF DESCRIPTION OF THE DRAWINGS

FIG. 1 is a schematic illustration of an exemplary gas turbine engine.

FIG. 2 is a schematic diagram of the fuel delivery system of FIG. 1.

FIG. 3 is a flowchart of a method for operating the gas turbine engine fuel delivery system of FIG. 2.

### DETAILED DESCRIPTION

The systems and methods disclosed herein include a method for operating a gas turbine engine in multiple modes. The operation of a gas turbine engine in multiple modes allows for minimizing gas fuel compression with the ability to request a higher supply pressure for transient loads events. In embodiments, the gas turbine engine operates in a steady state mode when efficiency is a larger concern and in a transient mode when quick load response is a concern. In a steady state mode the gas turbine engine operates with the metering/control valves in an open position and adjusts for an increase in load by increasing the pressure set point of the fuel system. In a transient mode the gas turbine engine operates with the pressure set point of the fuel system at higher pressure than the pressure needed to supply the current load. The control valves positions are changed or adjusted to adjust for an increase or decrease in load.

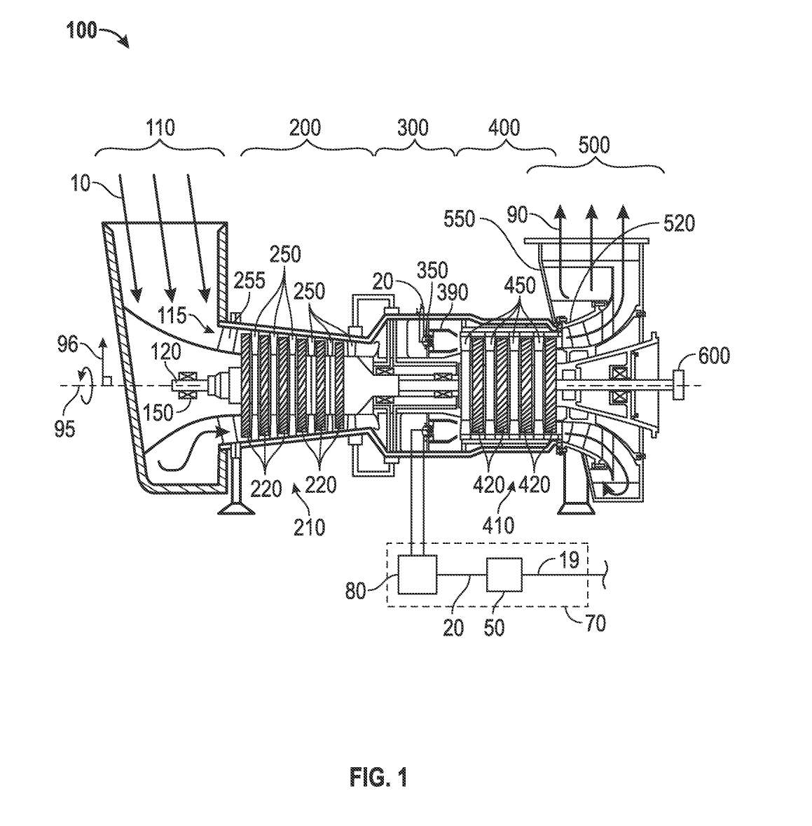

FIG. 1 is a schematic illustration of an exemplary gas turbine engine. Some of the surfaces and components have been left out or exaggerated (here and in other figures) for clarity and ease of explanation. Also, the disclosure may reference a forward and an aft direction. Generally, all references to “forward” and “aft” are associated with the flow direction of primary air (i.e., air used in the combustion process), unless specified otherwise. For example, forward is “upstream” relative to primary air flow, and aft is “downstream” relative to primary air flow.

In addition, the disclosure may generally reference a center axis 95 of rotation of the gas turbine engine, which may be generally defined by the longitudinal axis of its shaft 120 (supported by a plurality of bearing assemblies 150). The center axis 95 may be common to or shared with other engine concentric components. All references to radial, axial, and circumferential directions and measures refer to center axis 95, unless specified otherwise. The terms such as “inner” and “outer” generally indicate a lesser or greater radial distance from the center axis 95. A radial 96 may be in any direction perpendicular and radiating outward from center axis 95.

A gas turbine engine 100 includes an inlet 110, a shaft 120, a gas producer or “compressor” section 200, a combustor 300, a turbine section 400, an exhaust 500, and a power output coupling 600. The gas turbine engine 100 may have a single shaft or a dual shaft configuration.

The compressor section 200 includes a compressor rotor assembly 210, compressor stationary vanes (“stators”) 250, and inlet guide vanes 255. The compressor rotor assembly 210 mechanically couples to shaft 120. As illustrated, the compressor rotor assembly 210 is an axial flow rotor assembly. The compressor rotor assembly 210 includes one or more compressor disk assemblies 220. Each compressor disk assembly 220 includes a compressor rotor disk that is circumferentially populated with compressor rotor blades. Stators 250 axially follow each of the compressor disk assemblies 220. A compressor stage includes a compressor disk assembly 220 paired with the adjacent stators 250 that follow the compressor disk assembly 220. Compressor section 200 includes multiple compressor stages. Inlet guide vanes 255 axially precede the first compressor stage. The inlet guide vanes 255 may be variable guide vanes.

The combustor 300 includes one or more fuel injectors 350 and includes one or more combustion chambers 390. A fuel delivery system 70 supplies pressurized fuel to injectors 350. The fuel delivery system 70 includes a fuel system 80 and an active pressure control system 50. The fuel system 80 includes fuel line 20. Fuel supply line 19 supplies liquid or gas fuel from a fuel source (not shown) to fuel system 80.

The active pressure control system 50 supplies or controls the pressure set point (“set point”) of the fuel in fuel system 80. The active pressure control system 50 may include a fuel compressor, a fuel pump, an active pressure control valve, or any combination thereof. The fuel compressor and fuel pump may be driven by a variable speed motor. The active pressure control valve may adjust the pressure supplied by an off-skid source to the set point of fuel system 80. The active pressure control valve may be located on or off-skid. The active pressure control system 50 may also include supplemental pressure devices such as an accumulator or an off-skid fuel compressor. Active pressure control system 50 may also include other pressure supply sources and controllers.

The turbine section 400 includes a turbine rotor assembly 410, and turbine nozzles 450. The turbine rotor assembly 410 mechanically couples to the shaft 120. As illustrated, the turbine rotor assembly 410 is an axial flow rotor assembly. The turbine rotor assembly 410 includes one or more turbine disk assemblies 420. Each turbine disk assembly 420 includes a turbine disk that is circumferentially populated with turbine blades. Turbine nozzles 450 axially precede each of the turbine disk assemblies 420. Each turbine disk assembly 420 paired with the adjacent turbine nozzles 450 that precede the turbine disk assembly 420 is considered a turbine stage. Turbine section 400 includes multiple turbine stages.

The exhaust 500 includes an exhaust diffuser 520 and an exhaust collector 550.

One or more of the above components (or their subcomponents) may be made from stainless steel and/or durable, high temperature materials known as “superalloys”. A superalloy, or high-performance alloy, is an alloy that exhibits excellent mechanical strength and creep resistance at high temperatures, good surface stability, and corrosion and oxidation resistance. Superalloys may include materials such as HASTELLOY, INCONEL, WASPALOY, RENE alloys, HAYNES alloys, INCOLOY, MP98T, TMS alloys, and CMSX single crystal alloys.

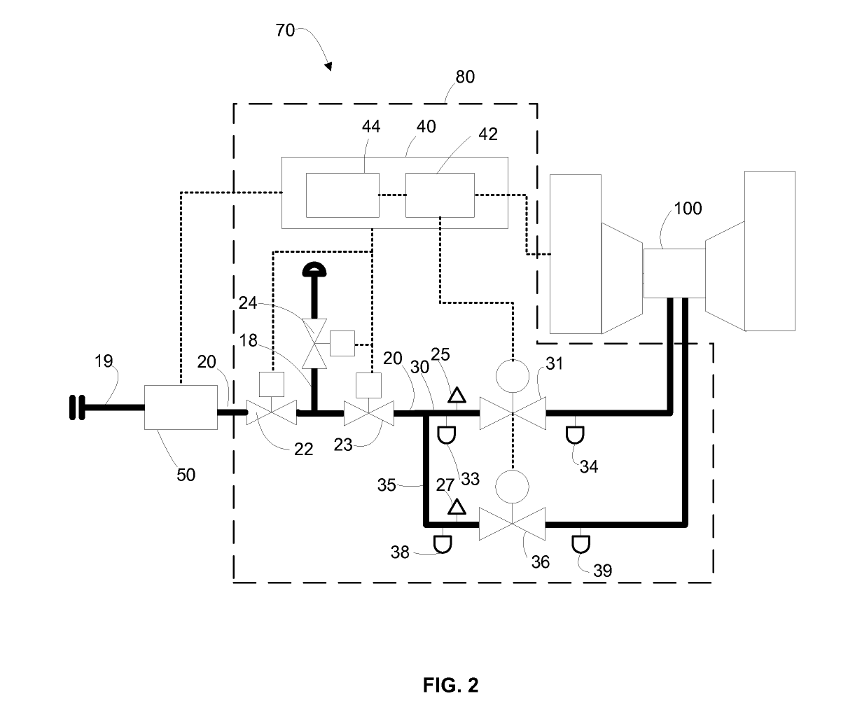

FIG. 2 is a schematic diagram of the fuel delivery system 70 of FIG. 1 and the gas turbine engine 100. Pressurized gas fuel leaves the active pressure control system 50 and travels along fuel line 20 to fuel system 80. Fuel line 20 may include block valves 22 and 23, with block valve 22 upstream of block valve 23. Vent line 18 may split or tee off from fuel line 20 between block valves 22 and 23. Vent line 18 may include vent valve 24.

Fuel line 20 may split into multiple fuel lines such as a primary fuel line 30 and a secondary fuel line 35. The split of fuel line 20 may be accomplished by fittings, manifolds, etc. In the embodiment shown in FIG. 2, fuel line 20 splits into primary fuel line 30 and secondary fuel line 35 after block valve 23.

Each of primary fuel line 30 and secondary fuel line 35 include one or more gas fuel control valves (“control valves”). Any number of control valves may be included in fuel system 80 in both series and parallel configurations. In the embodiment shown, primary fuel line 30 includes primary control valve 31 and secondary fuel line 35 includes secondary control valve 36. In some embodiments, a fuel line may include a primary control valve and a secondary control valve in series. Each fuel delivery line may also include sensing elements on either the upstream or downstream side of the fuel control valves. Exemplar sensors include pressure, temperature, and flow sensors.

In the embodiment shown in FIG. 2, primary fuel line 30 includes upstream pressure sensor 33, downstream pressure sensor 34, and upstream temperature sensor 25; and secondary fuel line 35 includes upstream pressure sensor 38, downstream pressure sensor 39, and upstream temperature sensor 27. In some embodiments, primary fuel line 30 splits into primary fuel delivery lines after primary control valve 31, and secondary fuel line 35 splits into secondary fuel delivery lines after secondary control valve 36. Each split may be accomplished by fittings, manifolds, etc. Each fuel injector 350 (shown in FIG. 1) may be connected to a primary fuel delivery line and to a secondary fuel delivery line. Primary fuel delivery line may include one or more valves, and may connect to one or more fuel injector 350 ports. Similarly, secondary fuel delivery line may include one or more valves, and may connect to one or more fuel injector 350 ports. Other fuel delivery lines and configurations may also be used. In some embodiments, the secondary fuel line 35 is a pilot fuel line.

Fuel system 80 also includes control system 40. Control system 40 includes turbine governor control module 42 and integrated pressure control module 44. Both turbine governor control module 42 and integrated pressure control module 44 may include or share an electronic control circuit having a central processing unit (“CPU”), such as a processor, or micro controller. Alternatively turbine governor control module 42 and integrated pressure control module 44 may be a programmable logic controller or a field-programmable gate array. Turbine governor control module 42 and integrated pressure control module 44 may also include or share memory for storing computer executable instructions, which may be executed by the CPU.

### INDUSTRIAL APPLICABILITY

Gas turbine engines may be suited for any number of industrial applications such as the oil and gas industry (including transmission, gathering, storage, withdrawal, and lifting of oil and natural gas), the power generation industry, cogeneration, aerospace, and other transportation industries.

Referring to FIG. 1, a gas (typically air 10) enters the inlet 110 as a “working fluid”, and is compressed by the compressor section 200. In the compressor section 200, the working fluid is compressed in an annular flow path 115 by the series of compressor disk assemblies 220. In particular, the air 10 is compressed in numbered “stages”, the stages being associated with each compressor disk assembly 220. For example, “4th stage air” may be associated with the 4th compressor disk assembly 220 in the downstream or “aft” direction, going from the inlet 110 towards the exhaust 500). Likewise, each turbine disk assembly 420 may be associated with a numbered stage.

Once air 10 leaves the compressor section 200, where it is diffused, it enters the combustor 300 and fuel is added. Air 10 and fuel are injected into the combustion chamber 390 via injector 350 and combusted. Energy is extracted from the combustion reaction via the turbine section 400 by each stage of the series of turbine disk assemblies 420. Exhaust gas 90 may then be diffused in exhaust diffuser 520, collected and redirected. Exhaust gas 90 exits the system via an exhaust collector 550 and may be further processed (e.g., to reduce harmful emissions, and/or to recover heat from the exhaust gas 90).

Referring to FIG. 2, during operation of gas turbine engine 100, control system 40 calculates the required supply pressure at the control valve to maintain turbine speed and load. The integrated pressure control module 44 acts as a feedback controller for the active pressure control system 50. The turbine governor control module 42 has information regarding the fuel demand, fuel characteristics, fuel pressures upstream of the control valve(s) and downstream of the control valve(s), and the control valve characteristics, such as the effective flow area versus command data. The turbine governor control module 42 may also have information about the required flows and pressures into the gas turbine engine to maintain combustion stability or to determine a set point for a desired increase in load. The turbine governor control module 42 determines the control valve(s) position and may change the position and effective flow area of the control valve(s) by communicating or transmitting a control signal or command to the control valve(s).

In the embodiment shown in FIG. 2, turbine governor control module 42 communicates control signals to primary control valve 31 and secondary control valve 36. Using the available information, the turbine governor control module 42 can limit and control fuel delivery. The turbine governor control module 42 may also determine the minimum pressure to satisfy the demand if the control valve(s) were at the most open, or any configurable target open position. This may result in turbine governor control module 42 communicating a control signal to the integrated pressure control module 44, a remote fuel gas compressor controller, or other off-skid controllers to change the set point or target value of the pressure supplied to the fuel system 80 by the active pressure control system 50. In one embodiment, active pressure control system 50 includes a variable speed motor; integrated pressure control module 44 communicates a control signal to the variable speed motor to speed up or slow down, increasing or decreasing the pressure supplied by a fuel compressor or a fuel pump, to modify the set point of fuel system 80. In another embodiment, the integrated pressure control module 44 communicates a control signal to an active pressure control valve to open or close to increase or decrease the pressure supplied to fuel system 80.

Pressure drops in the fuel system across the control valves may decrease the efficiency of fuel system 80, which may lead to a significant increase in the operating cost. Pressure and temperature drops across the control valves may also lead to sulfur deposition or other fouling of the control valves. The pressure and temperature drops across the control valves may be reduced by reducing the set point of fuel system 80 and by opening the control valves. Maintaining the control valves at a maximum and configurable open position may minimize the pressure loss across the valve and subsequently the required supply pressure.

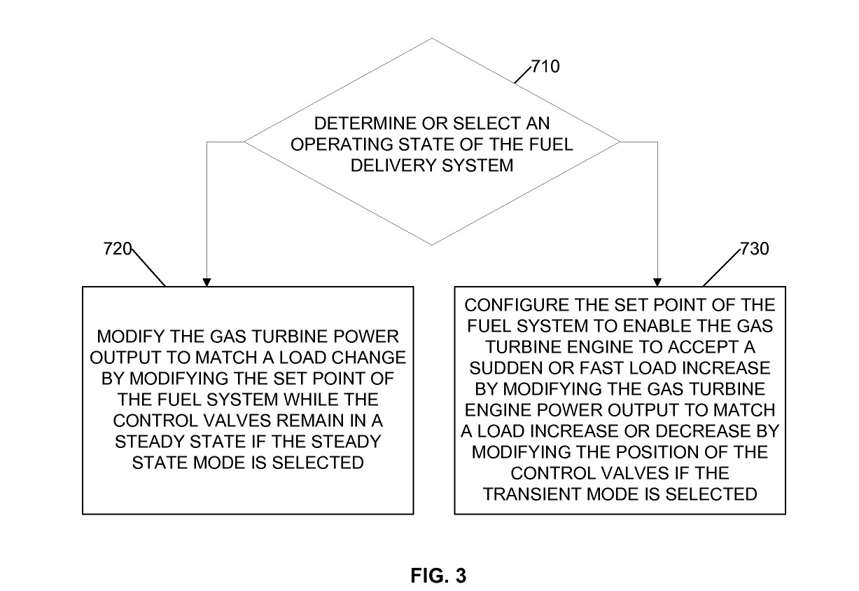

FIG. 3 is a flowchart of a method for operating the fuel delivery system 70 of FIG. 2. The fuel delivery system 70 may operate in one of a selection of operating states. The operating states include a steady state mode and a transient mode. The operating states may also include an a hybrid mode. The method includes determining or selecting an operating state of fuel delivery system 70 at step 710. The operating state may be manually selected or may be automated and integrated into a load control module of control system 40 or located remotely. Possible factors used by the load control module may include an operating schedule, historical data, turbine engine model data or models, turbine load demand, and information supplied by a plant management system. The load control module may also determine the set point of fuel system 80 based on a schedule or may be calculated based on the pressure downstream of the control valves and the fuel properties.

Step 710 is followed by modifying the gas turbine power output to match a load change by modifying the set point of fuel system 80 while maintaining the control valves in a steady state at step 720 if the steady state mode is selected. In one embodiment, the steady state is maintained by keeping the control valve in a steady position. In another embodiment, the steady state is maintained by maintaining a constant differential pressure across the control valve. The control valve may be in a fully opened position, a minimally closed position, or a position corresponding to a minimal and configurable pressure drop while being maintained in a steady state. Controlling the set point of fuel system 80 or the set point of the active pressure control system 50 may improve system efficiency by reducing or minimizing gas fuel compression energy consumption.

Step 710 is also followed by configuring the set point of the fuel system 80 to enable the gas turbine engine 100 to accept a sudden or fast load increase by modifying the gas turbine engine output to match a load increase or decrease by modifying the position of the control valves at step 730 if the transient mode is selected. Modifying the position of the control valves may include changing the position of the control valve and changing the effective flow area of the control valve. The transient mode may provide the ability to request a higher supply pressure for a transient load event.

A hybrid mode may increase or decrease the gas turbine engine output to match a load change in any combination or portion of the above listed steps 720 to 730. In one embodiment, a hybrid mode decreases the gas turbine engine 100 output to match a decrease in load by partially closing the control valves to match the load decrease by moving the control valves from a first position to a second position followed by decreasing the set point of fuel system 80 while simultaneously opening the control valves back to the first position. In another embodiment, a hybrid mode matches a load change by modifying the set point of fuel system 80 and by modifying the position of the control valves.

In the steady state mode the integrated pressure control module 44 receives a nominal command from the turbine governor control module 42 to modify the set point of fuel system 80 or active pressure control system 50 to supply the required pressure to supply the current required flow. In the transient mode the integrated pressure control module 44 receives a nominal command from the turbine governor control module 42 to modify the set point of fuel system 80 or the set point of active pressure control system 50 to supply the required pressure during steady state operation. The pressure supplied in the transient mode may be based on a percentage of the current required flow or may be based on a predetermined load output.

A change in the set point of fuel system 80 may be desirable when there is an increase in load and a requirement for higher pressure in one or more manifolds to supply the required fuel, a load decrease where the fuel pressure to fuel system 80 is required to change the fuel ratio to one or more manifolds and ensure combustor stability, or to move to a control regime where control system 40 is more stable.

As previously mentioned, in some embodiments, the active pressure control system 50 includes an active pressure control valve. The active pressure control valve may not be dependent on or sensitive to the valve characteristic, unlike the control valve(s). Using the method of FIG. 3 with the active pressure control valve to reduce the set point of fuel system 80 may shift sulfur deposition from the sensitive control valve(s) to the insensitive active pressure control valve. The use of active pressure control valve with other valves or pressure supply elements to change the set point of fuel system 80 may also reduce or eliminate sulfur deposition by “staging” the pressure and temperature reductions across the active pressure control valve and other elements, depending upon the nature of the vapor state sulfur and intermediate temperature recovery.

Gas turbine engine drive or operating cycles may include start-up, general operation, and shut-down. General operation may include operating the gas turbine engine at various loads including a full load, a partial load, and no load (idle). At least two of the modes of the method of FIG. 3 are used during the operating cycle and during the general operation of gas turbine engine 100. For example, in one embodiment, the general operation of a gas turbine engine, the operation between the start-up cycle and the shut-down cycles, includes the steady state mode and the transient mode.

The preceding detailed description is merely exemplary in nature and is not intended to limit the invention or the application and uses of the invention. The described embodiments are not limited to use in conjunction with a particular type of gas turbine engine fuel system. Hence, although the present disclosure, for convenience of explanation, depicts and describes a particular gas turbine engine gas fuel system, it will be appreciated that the fuel system in accordance with this disclosure can be implemented in various other configurations, can be used with various other types of gas turbine engines, and can be used in other types of machines.

Those of ordinary skill in the art will appreciate that the various illustrative logical blocks, modules, controllers, units, and algorithms described in connection with the embodiments disclosed herein can often be implemented as electronic hardware, computer software, or combinations of both. To clearly illustrate this interchangeability of hardware and software, various illustrative components, units, blocks, modules, and operations have been described above generally in terms of their functionality. Whether such functionality is implemented as hardware or software depends upon the particular system and design constraints imposed on the overall system. Persons of ordinary skill in the art can implement the described functionality in varying ways for each particular system, but such implementation decisions should not be interpreted as causing a departure from the scope of the invention. In addition, the grouping of functions within a unit, module, block or operation is for ease of description. Specific functions or operations can be moved from one unit, module or block without departing from the invention. Electronic content may include, for example, but is not limited to, data and/or applications which may be accessed through the system or systems.

The various illustrative logical blocks, units, operations and modules described in connection with the example embodiments disclosed herein, may be implemented or performed with, for example, but not limited to, a processor, such as a general purpose processor, a digital signal processor (“DSP”), an application-specific integrated circuit (“ASIC”), a field programmable gate array (“FPGA”) or other programmable logic devices, such as a programmable logic controller (“PLC”), discrete gate or transistor logic, discrete hardware components, or any combination thereof designed to perform the functions described herein. A general-purpose processor may be, for example, but not limited to, a microprocessor, but in the alternative, the processor may be any processor, controller, or microcontroller. A processor may also be implemented as a combination of computing devices, for example, but not limited to, a combination of a DSP and a microprocessor, a plurality of microprocessors, one or more microprocessors in conjunction with a DSP core, or any other such configuration.

The operations of a method or algorithm and the processes of a block or module described in connection with the example embodiments disclosed herein may be embodied directly in hardware, in a software module (or unit) executed by a processor, or in a combination of the two. A software module may reside in, for example, but not limited to, random access memory (“RAM”), flash memory, read-only memory (“ROM”), erasable programmable read only memory (“EPROM”), electrically erasable programmable read only memory (“EEPROM”), registers, hard disk, a removable disk, a compact disk (“CD-ROM”), or any other form of machine or non-transitory computer readable storage medium. An exemplary storage medium may be coupled to the processor such that the processor can read information from, and write information to, the storage medium. In the alternative, the storage medium may be integral to the processor. The processor and the storage medium may reside in an ASIC.

There is no intention to be bound by any theory presented in the preceding background or detailed description. It is also understood that the illustrations may include exaggerated dimensions to better illustrate the referenced items shown, and are not consider limiting unless expressly stated as such.

What is claimed is:

1. A method for operating a gas turbine engine during general operation, the gas turbine engine having a fuel system, the method comprising:
determining whether the gas turbine engine fuel system is in a steady state mode or a transient mode;
modifying the gas turbine engine power output to match a change of load or power demand on the gas turbine engine by modifying a pressure set point of the fuel system while maintaining a fuel control valve in a steady state when in the steady state mode; and
configuring the pressure set point of the fuel system to a point higher than a gas turbine engine load requires and modifying the gas turbine engine output to match a change of load or power demand on the gas turbine engine by modifying the position of the fuel control valve while maintaining the pressure set point of the fuel system constant when in the transient mode.

2. The method of claim 1, further comprising:
determining whether the gas turbine engine fuel system is in a hybrid mode in addition to the steady state mode and the transient mode; and
configuring the set point of the fuel system to a point higher than a gas turbine engine load requires and modifying the gas turbine engine output to match a load change of the gas turbine engine by modifying the position of the fuel control valve and by modifying the pressure set point of the fuel system when in the hybrid mode.

3. The method of claim 2, wherein the hybrid mode includes increasing the gas turbine engine output by increasing an effective flow area of the fuel control valve by moving the fuel control valve from a first position to a second position to match a load change followed by increasing the pressure set point of the fuel system and decreasing the effective flow area of the fuel control valve by moving the fuel control valve back to the first position while maintaining a steady gas turbine engine power output, and decreasing the gas turbine engine output by decreasing the effective flow area of the fuel control valve by moving the fuel control valve from a third position to a fourth position to match a load change followed by decreasing the pressure set point of the fuel system and increasing the effective flow area of the fuel control valve by moving the fuel control valve back to the third position while maintaining a steady gas turbine engine output.

4. The method of claim 1, further comprising:
determining whether the gas turbine engine fuel system is in a hybrid mode in addition to the steady state mode and the transient mode; and
increasing the gas turbine engine output to match a load change by increasing the fuel system pressure set point while maintaining the fuel control valve in the steady state, and decreasing the gas turbine engine output to match a load change by reducing the effective flow area of the fuel control valve while maintaining the pressure set point of the fuel system constant when in the hybrid mode.

5. The method of claim 1, further comprising:
determining whether the gas turbine engine fuel system is in a hybrid mode in addition to the steady state mode and the transient mode; and
increasing the gas turbine engine output to match a load change by increasing the fuel system pressure set point while maintaining the fuel control valve in the steady state, and decreasing the gas turbine engine output to match a load change by decreasing the fuel system pressure set point and reducing the effective flow area of the fuel control valve when in the hybrid mode.

6. The method of claim 1, further comprising:
determining whether the gas turbine engine fuel system is in a hybrid mode in addition to the steady state mode and the transient mode; and
increasing the gas turbine engine output to match a load change by increasing the effective flow area of the fuel control valve while maintaining the pressure set point of the fuel system constant, and decreasing the gas turbine engine output to match a load change by decreasing the fuel system pressure set point while maintaining the fuel control valve in the steady state when in the hybrid mode.

7. The method of claim 1, further comprising:
determining whether the gas turbine engine fuel system is in a hybrid mode in addition to the steady state mode and the transient mode; and
increasing the gas turbine engine output to match a load change by increasing the effective flow area of the fuel control valve while maintaining the pressure set point of the fuel system constant, and decreasing the gas turbine engine output to match a load change by decreasing the fuel system pressure set point and reducing the effective flow area of the fuel control valve when in the hybrid mode.

8. The method of claim 1, further comprising:
determining whether the gas turbine engine fuel system is in a hybrid mode in addition to the steady state mode and the transient mode; and
increasing the gas turbine engine output to match a load change by increasing the fuel system pressure set point and increasing the effective flow area of the fuel control valve, and decreasing the gas turbine engine output to match a load change by decreasing the fuel system pressure set point while maintaining the fuel control valve in the steady state when in the hybrid mode.

9. The method of claim 1, further comprising:
determining whether the gas turbine engine fuel system is in a hybrid mode in addition to the steady state mode and the transient mode; and
increasing the gas turbine engine output to match a load change by increasing the fuel system pressure set point and increasing the effective flow area of the fuel control valve, and decreasing the gas turbine engine output to match a load change by reducing the effective flow area of the fuel control valve while maintaining the pressure set point of the fuel system constant when in the hybrid mode.

10. The method of claim 1, wherein modifying the pressure set point of the fuel system includes increasing or decreasing a pressure supplied by an active pressure control system.

11. The method of claim 10, wherein the active pressure control system includes a variable speed compressor.

12. The method of claim 10, wherein the active pressure control system includes an active pressure control valve.

13. The method of claim 1, wherein maintaining the steady state includes keeping the fuel control valve in a steady position.

14. The method of claim 1, wherein maintaining the steady state includes maintaining a constant differential pressure across the fuel control valve.

15. A method for general operation of a gas turbine engine, comprising:
selecting an operating state of the gas turbine engine from a selection of operating states including a steady state mode and a transient mode;
increasing a gas turbine engine fuel compressor set point to increase a gas turbine engine output while maintaining a gas turbine engine fuel control valve in a steady state position in response to an increase in demand if the steady state mode is selected; and
increasing an effective flow area of the gas turbine engine fuel control valve to increase the gas turbine engine output while maintaining the gas turbine engine fuel compressor set point constant in response to an increase in demand if the transient mode is selected.

16. The method of claim 15, wherein increasing the gas turbine engine fuel compressor set point when in a steady state mode includes maintaining a secondary control valve in the same position, and increasing the effective flow area of the gas turbine engine fuel control valve when in the transient mode includes increasing the effective flow area of the secondary control valve.

17. The method of claim 16, wherein the secondary control valve is a pilot fuel control valve.

18. A method for controlling a gas turbine engine fuel system having a fuel system pressure, a fuel control valve, and a control system including a turbine governor control module and an integrated pressure control module, the method comprising:
selecting an operating state of the gas turbine engine from a selection of operating states including a steady state mode and a transient mode;
determining a minimum pressure to satisfy a demand of the gas turbine engine with the turbine governor control module;
modifying the fuel pressure including
sending a control signal from the turbine governor control module to the integrated pressure control module to increase or decrease a supplied pressure to match the fuel system pressure to the determined minimum pressure while the fuel control valve remains at a target open position when the fuel system is operating in the steady state mode, and
sending a control signal from the turbine governor control module to the fuel control valve to increase or decrease the effective flow area of the fuel control valve to match a pressure downstream of the fuel control valve to the determined minimum pressure while a pressure set point of the supplied pressure remains constant when the fuel system is operating in the transient mode.

19. The method of claim 18, wherein modifying the fuel pressure includes sending a control signal from the turbine governor control module to a secondary control valve to increase or decrease the effective flow area of the secondary control valve to maintain a preselected flow ratio between the fuel control valve and the secondary control valve when the fuel system is operating.

20. The method of claim 18, wherein modifying the fuel pressure includes maintaining a secondary control valve in a constant position when the fuel system is operating in the steady state mode, and sending a control signal from the turbine governor control module to the secondary control valve to increase or decrease the effective flow area of the secondary control valve to maintain a preselected flow ratio between the fuel control valve and the secondary control valve when the fuel system is operating in the transient mode.
